(19) United States
(12) Patent Application Publication
(10) Pub. No.: US 2025/0369753 A1
(43) Pub. Date: Dec. 4, 2025

(54) PHOTODETECTION DEVICE, SYSTEM, AND INFORMATION PROCESSING DEVICE

(71) Applicant: SONY SEMICONDUCTOR SOLUTIONS CORPORATION, KANAGAWA (JP)

(72) Inventor: Yasuhiro HASHIMOTO, KANAGAWA (JP)

(21) Appl. No.: 18/870,806

(22) PCT Filed: May 30, 2023
(86) PCT No.: PCT/JP2023/020141

§ 371 Date: Dec. 2, 2024

(30) Foreign Application Priority Data
Jun. 7, 2022 (JP) 2022-092532

(51) Int. Cl. G01B 11/25

(52) U.S. Cl. CPC G01B 11/254

(57) ABSTRACT

An object is to realize highly accurate and high-speed three-dimensional shape measurement. A photodetection device includes a light receiving sensor, a processing circuit, and a register. The light receiving sensor acquires pattern information projected onto a subject. The processing circuit acquires depth information on the basis of the pattern information, sets a point group density for each region in the depth information, sets a point group on the basis of the point group density, and outputs information regarding the point group. The register stores a parameter for processing in the processing circuit and a control signal of the processing circuit.

### TECHNICAL FIELD

The present disclosure relates to a photodetection device, a system, and an information processing device.

### BACKGROUND ART

In automated driving and remote control, it is important to acquire the state of the surrounding environment where the target vehicle and device are present. In order to acquire such a surrounding situation, three-dimensional shape measurement processing may be used. The three-dimensional shape measurement can be realized, for example, by calculating depth information on the basis of the principle of triangulation from phase information acquired by reading a predetermined projection pattern by an image sensor in a state where the pattern is projected onto a subject.

In the three-dimensional shape measurement processing, the accuracy of the position/posture estimation is improved as the point group of which information is acquired by the image sensor is set to a higher density. However, increasing the density of the point group causes a problem that the processing time becomes longer. On the other hand, it is also possible to set a low density point group, but setting a low density point group causes a decrease in accuracy of position/posture estimation.

### CITATION LIST

### Patent Document

### Patent Document 1: Japanese Patent Application Laid-Open No. 2011 027724

### SUMMARY OF THE INVENTION

### Problems to be Solved by the Invention

Therefore, the present disclosure provides a photodetection device that sets an appropriate density of a point group and realizes highly accurate and high-speed three-dimensional shape measurement.

### Solutions to Problems

According to an embodiment, the photodetection device includes a light receiving sensor, a processing circuit, and a register. The light receiving sensor acquires pattern information projected onto a subject. The processing circuit acquires depth information on the basis of the pattern information, sets a point group density for each region in the depth information, sets a point group on the basis of the point group density, and outputs information regarding the point group. The register stores a parameter for processing in the processing circuit and a control signal of the processing circuit.

The processing circuit may set the point group density on the basis of the pattern information.

The processing circuit may generate a mask on the basis of the pattern information, and set the point group density on the basis of the mask.

The processing circuit may extract an edge region from the pattern information, and generate the mask on the basis of the edge information.

The processing circuit may extract a flat region from the pattern information, and generate the mask on the basis of information of the flat region.

The processing circuit may obtain information of the flat region on the basis of a reliability map and the edge region, and generate the mask.

The processing circuit may generate the mask on the basis of a reliability map and the edge region.

The processing circuit may generate the reliability map on the basis of a region obtained by projecting a pattern onto the subject.

The processing circuit may generate the mask by calculating a product of the reliability map, which indicates a region where a pattern is projected onto the subject, and information obtained by inverting the edge region.

The processing circuit may set the point group density lower in the flat region than in the edge region.

The photodetection device may further include a light emitting element that projects a phase shift pattern onto the subject, and the light receiving sensor may acquire reflected light from the subject on which the phase shift pattern is projected as the pattern information.

According to an embodiment, a system includes: one or a plurality of solid-state imaging devices including the photodetection device according to any one of the above; an estimation unit that acquires a position and a posture on the basis of depth information in a point group acquired from the solid-state imaging device; and a register control unit that transmits a parameter and control to a register of the solid-state imaging device, the parameter being regarding acquisition processing of the point group.

According to an embodiment, an information processing device includes a processing circuit. The processing circuit acquires depth information on the basis of acquired pattern information of a subject, sets a point group density for each region in the depth information, sets a point group on the basis of the point group density, and outputs information regarding the point group.

### BRIEF DESCRIPTION OF DRAWINGS

FIG. 1 is a block diagram schematically illustrating a system according to an embodiment.

FIG. 2 is a flowchart illustrating an example of processing of a photodetection device according to an embodiment.

FIG. 3 is a view illustrating an example of a phase pattern to be projected according to an embodiment.

FIG. 4 is a diagram illustrating an example of imaged pattern information according to an embodiment.

FIG. 5 is a diagram illustrating an example of a reconstructed phase image according to an embodiment.

FIG. 6 is a diagram illustrating an example of a depth image according to an embodiment.

FIG. 7 is a diagram illustrating an example of an edge region according to an embodiment.

FIG. 8 is a diagram illustrating an example of flat region information according to an embodiment.

FIG. 9 is a diagram illustrating an example of decimation according to an embodiment.

FIG. 10 is a diagram illustrating an example of decimation according to an embodiment.

FIG. 11 is a diagram illustrating an example of decimation according to an embodiment.

FIG. 12 is a diagram illustrating an example of an output in which the density of a point group is controlled according to an embodiment.

### MODE FOR CARRYING OUT THE INVENTION

The following is a description of an embodiment of the present disclosure, with reference to the drawings. The drawings are used for explanation, and the shape and size of each component in actual devices, the ratios of size to other components, and the like are not necessarily as illustrated in the figure. Furthermore, since the drawings are illustrated in a simplified manner, configurations necessary for implementation other than those illustrated in the drawings are appropriately provided.

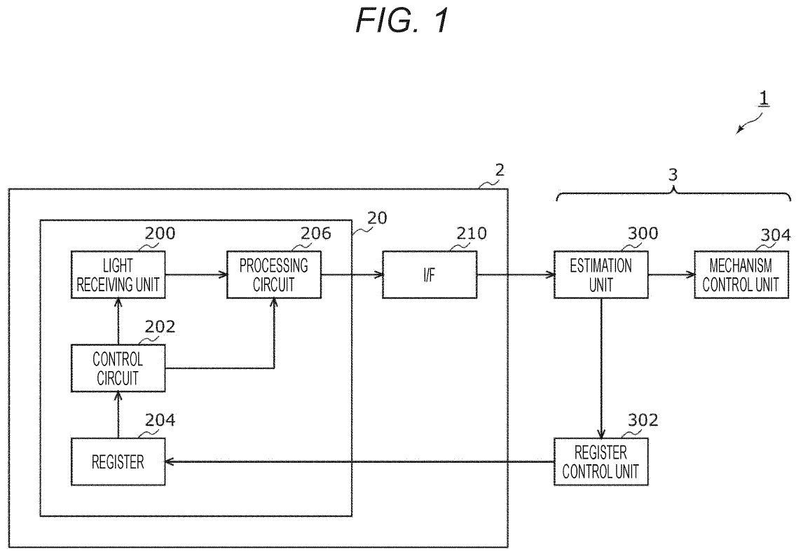

FIG. 1 is a block diagram schematically illustrating a system 1 according to an embodiment. The system 1 includes a solid-state imaging device 2 and a post-stage processing unit 3. The system 1 acquires information by the solid-state imaging device 2, for example. The system 1 estimates a three-dimensional shape of a subject by the post-stage processing unit 3 or estimates the position and posture of a vehicle, a robot, or the like on which the solid-state imaging device 2 is mounted on the basis of the acquired information. In FIG. 1, one solid-state imaging device 2 is illustrated in the system 1, but the present invention is not limited thereto, and a plurality of solid-state imaging devices 2 may be provided.

The solid-state imaging device 2 includes a photodetection device 20 and an interface (hereinafter, it is referred to as an I/F 210.). The photodetection device 20 executes signal processing based on the intensity of the received light, and outputs a result of the signal processing to the outside of the solid-state imaging device 2 via the I/F 210.

Although not illustrated, the solid-state imaging device 2 includes storage circuits such as a memory and a storage in at least one of the inside or the outside of the photodetection device 20 as necessary. In a case where information processing by software is specifically realized by using a hardware resource including a general-purpose processing circuit or the like, a program or the like may be stored in these storage circuits.

The photodetection device 20 includes a light receiving unit 200, a control circuit 202, a register 204, and a processing circuit 206. The photodetection device 20 may include light receiving elements included in a general camera module, a processing circuit capable of performing processing in the following description, and the like. Furthermore, the light receiving unit 200, the control circuit 202, the register 204, and the processing circuit 206 may be mounted on a stacked semiconductor.

The light receiving unit 200 includes, for example, a light receiving element (photoelectric conversion element) such as a photo diode (PD) and a pixel circuit that appropriately outputs an analog signal output from the light receiving element. The output from the pixel circuit may be an analog signal or a digital signal after analog-digital conversion. The light receiving unit 200 includes, for example, a light receiving sensor in which a light receiving region is defined by a pixel array in which light receiving elements are arranged in a two-dimensional array.

The control circuit 202 is a circuit that executes control of the solid-state imaging device 20. The register 204 is, for example, a register that stores a parameter defined in advance or a parameter set by external control. The control circuit 202 controls the light receiving unit 200 or the processing circuit 206 on the basis of a control signal or a parameter stored in the register.

The processing circuit 206 is a circuit that executes various types of signal processing in the photodetection device 20 and the solid-state imaging device 2. The processing circuit 206 may be a general-purpose processor capable of executing information processing by software, or may be a circuit limited to an application such as an application specified integrated circuit (ASIC). In addition, the processing circuit 206 may be a programmable circuit such as a field-programmable gate array (FPGA).

The photodetection device 20 outputs the signal processed by the processing circuit 206. The solid-state imaging device 2 outputs necessary data to the outside via the I/F 210. The necessary data may include data processed by the processing circuit 206.

The post-processing unit 3 is a unit that executes processing based on data output from the solid-state imaging device 2. The post-processing unit 3 includes, for example, an estimation unit 300, a register control unit 302, and a mechanism control unit 304 as a simple configuration. The post-processing unit 3 estimates, for example, position and posture information of a housing of a vehicle, a robot, or the like on which the solid-state imaging device 2 is mounted, generates an appropriate control signal for the housing, and appropriately controls the housing.

The estimation unit 300 includes, for example, various circuits, and acquires the three-dimensional shape of the subject and the information of the position and posture of the housing on the basis of the signal acquired from the solid-state imaging device 2.

The register control unit 302 sets an appropriate parameter in the register inside the photodetection device 20 on the basis of the estimation result of the estimation unit 300 or the data output from the processing circuit 206. As another example, the register control unit 302 may write a signal for controlling the photodetection device 20 into the register 204.

The mechanism control unit 304 performs control so that the housing can move safely on the basis of, for example, the position and posture information estimated by the estimation unit 300. In addition, the mechanism control unit 304 may control the imaging direction or the like of the solid-state imaging device 2 on the basis of the position and posture information estimated by the estimation unit 300.

Note that, although not illustrated, the solid-state imaging device 2 may further include a light emitting unit (light emitting element) that projects a predetermined pattern onto the subject inside or outside the photodetection device 20. As another example, the light emitting unit may be provided at any location inside or outside the system. The photodetection device 20 acquires an image of the subject of the phase pattern projected via the light emitting element.

The system 1 according to the present disclosure estimates the three-dimensional shape of the subject or the position and posture information of the housing by the above-described configuration, and realizes appropriate control. Next, processing of the photodetection device 2 will be described.

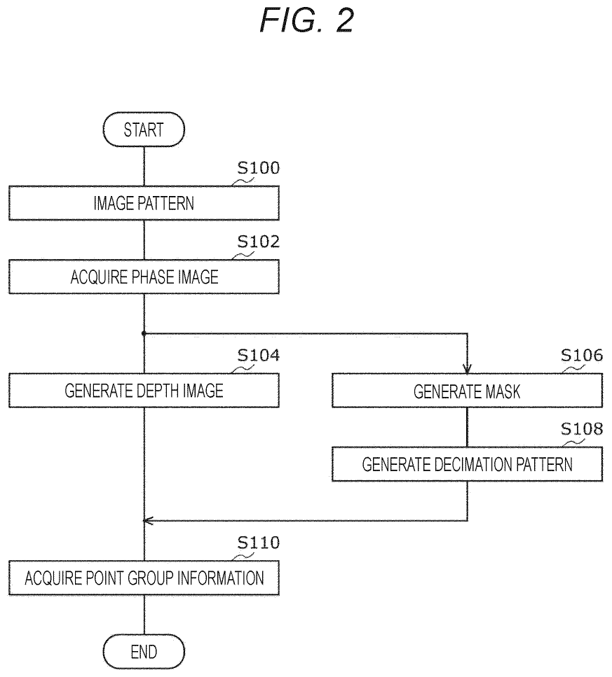

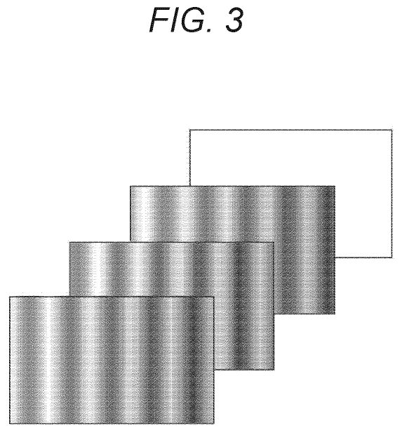

FIG. 2 is a flowchart illustrating processing of the photodetection device 20 according to an embodiment. The solid-state imaging device 2 or the system 1 performs projection having the phase pattern illustrated in FIG. 3 on the subject before starting this processing. The photodetection device 20 acquires information of the subject on which such a phase pattern is projected. Note that the pattern to be projected may include a pattern having uniform intensity for use in removal of the influence in the normal direction.

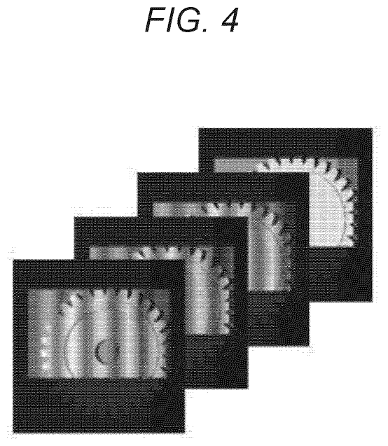

The light receiving unit 200 images the phase pattern reflected on the subject and acquires the phase pattern as pattern information for each piece of projected phase information (S100). In a case where the phase of the projection range starts from 0 as necessary, the processing circuit or the pixel circuit may output a result obtained by adding an offset to distinguish the projection range from the non-projection range. FIG. 4 is a diagram illustrating an example of pattern information obtained by imaging a subject on which a phase pattern is projected.

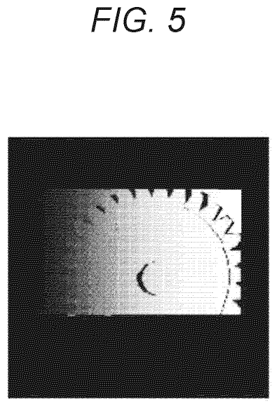

The processing circuit 206 acquires the phase image on the basis of the pattern information acquired by the light receiving unit 200 (S102). This phase image is an image acquired by a general method on the basis of a plurality of pieces of imaged pattern information illustrated in FIG. 4. As a non-limiting example, the processing circuit acquires this phase image using a phase shift method. FIG. 5 is a diagram illustrating an example of a reconfigured phase image in a case where the pattern of FIG. 4 is acquired.

The processing circuit 206 may apply filter processing such as a noise removal filter to the acquired phase image as necessary. As a non-limiting example, the processing circuit 206 may execute noise removal by using a moving average filter, a median filter, or the like for the phase image.

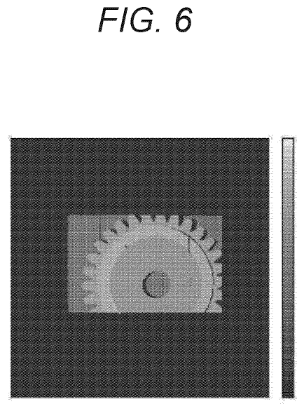

The processing circuit 206 generates a depth image from the acquired phase image or the noise-removed phase image (S104). FIG. 6 is a diagram illustrating an example of a depth image generated by the processing circuit 206. Similarly to the above, the processing circuit 206 may acquire the depth image by the phase shift method as a non-limiting example. This processing may also be executed by the processing circuit 206 using a general method.

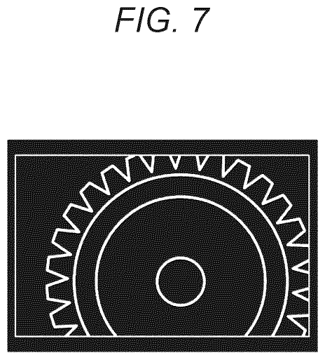

In parallel with the processing of S104 or before and after the processing of S104, the processing circuit 206 generates a mask on the basis of the phase image (that is, pattern information) (S106). As an example, the processing circuit 206 acquires edge information as illustrated in FIG. 7 from the phase image and generates a mask on the basis of the edge information. As a non-limiting example, the processing circuit 206 may acquire the edge image by using a Sobel filter, a Laplacian filter, or the like. In the figure, a white region indicates an edge region.

The processing circuit 206 acquires information of the flat region by integrating the acquired image obtained by inverting the edge information and the reliability map. The processing circuit 206 generates a mask from the acquired information of the flat region. Furthermore, the processing circuit 206 may generate a mask from the information of the edge region. That is, the processing circuit 206 may generate a mask from any one of the information of the edge region and the information of the flat region, or may generate a mask corresponding to each region from both of them.

As an example, the processing circuit 206 may generate a reliability map in which a region of a light receiving pixel where information can be appropriately acquired with respect to a region where a phase pattern is projected is set as a region where information with high reliability can be acquired. As another example, the processing circuit 206 may generate a reliability map in which a region having a pixel value equal to or larger than a predetermined value is set as a region with high reliability in an image which is acquired by the light receiving element in a case where a uniform pattern (or another phase pattern) in FIG. 3 is projected and in which a low-pass filter is applied to the generated image, for example.

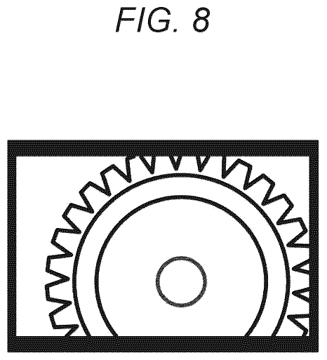

The processing circuit 206 can generate a mask indicating the flat region by acquiring a product of the generated reliability map and the inverted edge information. FIG. 8 is a diagram illustrating an example of a flat region acquired by the above calculation. The flat region illustrated in this figure may be used as the region of the mask. In the figure, a white region indicates a flat region.

After generating the mask, the processing circuit 206 generates a decimation pattern for setting the density of the point group that determines the density of the data to be output to the post-processing unit 3 (S108). This decimation pattern is a pattern for controlling the density of points at which the depth information or the information related to the depth information is output.

For example, the estimation unit 300 in the system 1 uses appropriate information regarding a point in the acquired image as an input depending on the estimation technique. In the processing of S108, the processing circuit 206 determines a point at which the point group information required by the estimation unit 300 is output on the basis of the mask generated in S106. As an example, the information of this point may be determined on the basis of a Polygon File Format (PLY) or a format conforming to PLY.

In the restoration of the three-dimensional shape, the information of the points in the edge region or the region around the edge is more important than the information on the points in the flat region. Therefore, in the present disclosure, the processing circuit performs control such that more information about the edge region is output than information about the flat region.

As an example, the processing circuit 206 may output the depth information and the like in all the pixels for the edge region, and may output the depth information and the like in the thinned pixels for the flat region.

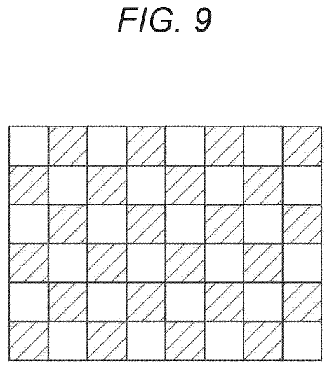

FIG. 9 is a diagram illustrating an example of decimation according to an embodiment. For example, the processing circuit 206 may perform control to decimate the information of the shaded portion in the figure in the flat region and acquire information of other pixels. In this case, the rate of outputting information in the flat region is about ½.

FIG. 1C is a diagram illustrating another example of decimation according to an embodiment. For example, the processing circuit 206 may perform control to decimate the information of the shaded portion in the figure in the flat region and acquire the other pixel information. In this case, the rate of outputting information in the flat region is about ⅓.

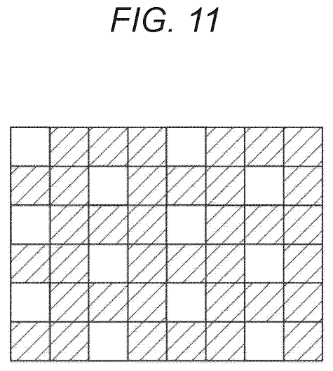

FIG. 11 is a diagram illustrating another example of decimation according to an embodiment. For example, the processing circuit 206 may perform control to decimate the information of the shaded portion in the figure in the flat region and acquire the other pixel information. In this case, the rate of outputting information in the flat region is about ¼.

As in some examples described above, the processing circuit 206 determines the density of the point group to which the information is output on the basis of the mask and the preset decimation rate.

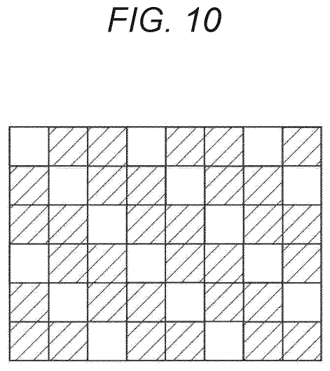

In FIGS. 9 to 11, the decimation rate is uniformly determined in the flat region in the image, but the present invention is not limited thereto. For example, the processing circuit 206 may calculate the area of the flat region and change the decimation rate on the basis of the area. For example, the processing circuit 206 may be set so as not to decimate much in a region where the area of the flat region is narrow, and set so as to increase the decimation rate in a region wider than the narrow region.

Finally, the processing circuit 206 acquires data in which the density of the point group is different between the edge region and the flat region as point group information on the basis of the decimation pattern generated in S108, and outputs the acquired data (S110). The estimation unit 300 can execute restoration of the three-dimensional shape using the point group data.

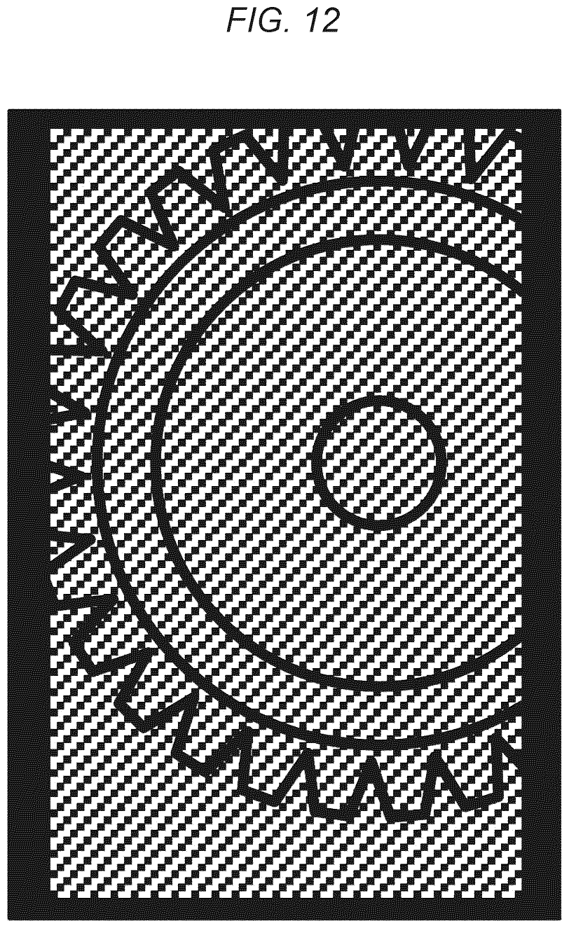

FIG. 12 is a diagram illustrating an example of a point group output from the photodetection device 20 according to an embodiment. A point where the data of the point group is output is expressed in black, and a point where the data of the point group is not output is expressed in white. As an example, the output rate of the point group in the flat portion is ⅓. As illustrated in FIG. 12, it is shown that a point group having a high density in the edge region and a low density in the flat region can be appropriately output.

As described above, even if the density of the point group is low in the flat region, the accuracy is not greatly reduced, but when the density of the point group is low in the edge region, it is difficult to realize appropriate restoration.

On the other hand, according to the present embodiment, it is possible to appropriately output the point group data of the edge region and to reduce and output the point group data of the flat region. As described above, in the present disclosure, if there is an acquired phase image, the data amount can be reduced by appropriately setting the density of the point group for each region.

As a result, it is possible to reduce the time cost for acquiring the point group data and the calculation cost on the photodetection device side without reducing the accuracy of the shape restoration, and it is possible to greatly reduce the memory access time that can be a bottleneck on the post-processing unit side. Furthermore, the latency in the photodetection device can also be reduced, and for example, it is possible to desire further improvement in the accuracy of the shape restoration by improving the frame rate or the like.

Note that, in the photodetection device, the configuration including the light receiving elements has been described, but as can be understood from the description, an information processing device that executes processing without the light receiving elements is naturally included in the embodiment of the present disclosure.

The embodiment described above may have the following forms.

(1)

A photodetection device including:
a light receiving sensor;
a processing circuit; and
a register,
in which the light receiving sensor acquires pattern information projected onto a subject,
the processing circuit
   acquires depth information on the basis of the pattern information,
   sets a point group density for each region in the depth information,
   sets a point group on the basis of the point group density, and
   outputs information regarding the point group, and
the register
   stores a parameter for processing in the processing circuit and a control signal of the processing circuit.

(2)

The photodetection device according to (1), in which
the processing circuit
   sets the point group density on the basis of the pattern information.

(3)

The photodetection device according to (2), in which
the processing circuit
   generates a mask on the basis of the pattern information, and
   sets the point group density on the basis of the mask.

(4)

The photodetection device according to (3), in which
the processing circuit
   extracts an edge region from the pattern information, and
   generates the mask on the basis of the edge information.

(5)

The photodetection device according to (4), in which
the processing circuit
   extracts a flat region from the pattern information, and
   generates the mask on the basis of information of the flat region.

(6)

The photodetection device according to (5), in which
the processing circuit
   obtains information of the flat region on the basis of a reliability map and the edge region, and generates the mask.

(7)

The photodetection device according to (5) or (6), in which
the processing circuit
   generates the mask on the basis of a reliability map and the edge region.

(8)

The photodetection device according to (7), in which
the processing circuit
   generates the reliability map on the basis of a region obtained by projecting a pattern onto the subject.

(9)

The optical information device according to (8), in which
the processing circuit
   generates the mask by calculating a product of the reliability map, which indicates a region where a pattern is projected onto the subject, and information obtained by inverting the edge region.

(10)

The photodetection device according to any one of (5) to (9), in which
the processing circuit
   sets the point group density lower in the flat region than in the edge region.

(11)

The photodetection device according to any one of (1) to (10), further including
a light emitting element that projects a phase shift pattern onto the subject,
in which the light receiving sensor acquires, as the pattern information, reflected light from the subject on which the phase shift pattern is projected.

(12)

A system including:
one or a plurality of solid-state imaging devices including the photodetection device according to any one of (1) to (11);
an estimation unit that acquires a position and a posture on the basis of depth information in a point group acquired from the solid-state imaging device; and
a register control unit that transmits a parameter and control to a register of the solid-state imaging device, the parameter being regarding acquisition processing of the point group.

(13)

An information processing device including a processing circuit,
in which the processing circuit
   acquires depth information on the basis of acquired pattern information of a subject,
   sets a point group density for each region in the depth information,
   sets a point group on the basis of the point group density, and
   outputs information regarding the point group.

Aspects of the present disclosure are not limited to the above-described embodiment, and include various conceivable modifications. The effects of the present disclosure are not limited to the above-described contents. The components in each of the embodiments may be appropriately combined and applied. That is, various additions, modifications, and partial deletions can be made without departing from the conceptual idea and gist of the present disclosure derived from the contents defined in the claims and equivalents and the like thereof.

### REFERENCE SIGNS LIST

1 System
2 Solid-state imaging device
20 Photodetection device
200 Light receiving unit
202 Control circuit
204 Register
206 Processing circuit
210 I/F
3 Post-processing unit
300 Estimation unit
302 Register control unit
304 Mechanism control unit

What is claimed is:

1. A photodetection device comprising:
a light receiving sensor;
a processing circuit; and
a register,
wherein the light receiving sensor acquires pattern information projected onto a subject,
the processing circuit
acquires depth information on a basis of the pattern information,
sets a point group density for each region in the depth information,
sets a point group on a basis of the point group density, and
outputs information regarding the point group, and the register
stores a parameter for processing in the processing circuit and a control signal of the processing circuit.

2. The photodetection device according to claim 1, wherein
the processing circuit
sets the point group density on a basis of the pattern information.

3. The photodetection device according to claim 2, wherein
the processing circuit
generates a mask on a basis of the pattern information, and
sets the point group density on a basis of the mask.

4. The photodetection device according to claim 3, wherein
the processing circuit
extracts an edge region from the pattern information, and
generates the mask on a basis of the edge information.

5. The photodetection device according to claim 4, wherein
the processing circuit
extracts a flat region from the pattern information, and
generates the mask on a basis of information of the flat region.

6. The photodetection device according to claim 5, wherein
the processing circuit
obtains information of the flat region on a basis of a reliability map and the edge region, and generates the mask.

7. The photodetection device according to claim 5, wherein
the processing circuit
generates the mask on a basis of a reliability map and the edge region.

8. The photodetection device according to claim 7, wherein
the processing circuit
generates the reliability map on a basis of a region obtained by projecting a pattern onto the subject.

9. The photodetection device according to claim 8, wherein
the processing circuit
generates the mask by calculating a product of the reliability map, which indicates a region where a pattern is projected onto the subject, and information obtained by inverting the edge region.

10. The photodetection device according to claim 5, wherein
the processing circuit
sets the point group density lower in the flat region than in the edge region.

11. The photodetection device according to claim 1, further comprising
a light emitting element that projects a phase shift pattern onto the subject,
wherein the light receiving sensor acquires, as the pattern information, reflected light from the subject on which the phase shift pattern is projected.

12. A system comprising:
one or a plurality of solid-state imaging devices including the photodetection device according to claim 1;
an estimation unit that acquires a position and a posture on a basis of depth information in a point group acquired from the solid-state imaging device; and
a register control unit that transmits a parameter and control to a register of the solid-state imaging device, the parameter being regarding acquisition processing of the point group.

13. An information processing device comprising a processing circuit,
wherein the processing circuit
acquires depth information on a basis of acquired pattern information of a subject,
sets a point group density for each region in the depth information,
sets a point group on a basis of the point group density, and
outputs information regarding the point group.
